(19) United States
(12) Patent Application Publication
(10) Pub. No.: US 2014/0064871 A1
(43) Pub. Date: Mar. 6, 2014

(54) KEEPER FOR OFF ROAD VEHICLE STORAGE TIEDOWN

(71) Applicant: David Blow, Ellis Grove, IL (US)

(72) Inventor: David Blow, Ellis Grove, IL (US)

(21) Appl. No.: 13/776,817

(22) Filed: Feb. 26, 2013

Related U.S. Application Data
(60) Provisional application No. 61/603,634, filed on Feb. 27, 2012.

(51) Int. Cl. B60P 7/08

(52) U.S. Cl. CPC B60P 7/0807
USPC 410/101

(57) ABSTRACT

A keeper (10) used with a tie down to secure items (I) of cargo in place during transport from one place to another in a vehicle carrier (C). A rod (12) has a length greater than the height of the carrier and is sized to fit through a channel (H) formed in the carrier. One end (14) of the rod is threaded for securing the rod to the carrier using fasteners (16, 18, 20). An eyelet (30) on the opposite end of the rod protrudes above a surface of the carrier when the rod is installed. The tie down (T) used to secure the items in the carrier is either fitted through or attached to the eyelet for the eyelet to hold the tie down in place regardless of the terrain traversed by the vehicle as it moves the cargo from the one place to the other.

### CROSS REFERENCE TO RELATED APPLICATIONS

The present application is related to, and claims priority from, U.S. provisional Patent Application Ser. No. 61/603,634 filed on Feb. 27, 2012, which is herein incorporated by reference.

### STATEMENT REGARDING FEDERALLY SPONSORED RESEARCH OR DEVELOPMENT

Not Applicable.

### BACKGROUND OF THE INVENTION

This invention relates to off-road vehicles such as ATVs and UTVs; and, more particularly to a keeper or anchor for use in stowing cargo in a storage compartment of the vehicle, the keeper being used with straps and the like used to tie down the cargo and keep it in place while the vehicle is traversing off-road terrain.

ATVs and UTVs are extensively used for traveling “off the beaten path” and typically traverse rough terrain that is hilly, tree covered and/or rocky, has streams or brooks that must be crossed, and generally is difficult to maneuver over. Often in going from one place to another in one of these vehicles, the rider also is transporting some type of cargo. This may be sport or camping gear, but can also include foodstuffs and like for consumption at a remote destination (e.g., a cabin or lodge), equipment for use at a work site, parts for equipment, etc. Many of these objects are bulky or come in odd shapes and sizes, and therefore are not easily stored for transport. Further, given the ruggedness of the terrain over which the cargo must be moved, it is important that they be packaged and stored so that they are not damaged or lost in transit.

Various types of tie downs are available for securing the items in a carrier that is usually located on the back of the vehicle, behind the driver. Ropes and straps are commonly used for this purpose. It will understood by those skilled in the art that while moving from one point to another, tie downs can come loose or even break, with the result that cargo may be damaged or lost. The keeper of the present invention is for use with various tie downs to insure that they stay in place and that whatever is being transported can be done so safely.

### BRIEF SUMMARY OF THE INVENTION

The present invention is directed to a keeper or anchor that is installed on the carrier of an ATV or UTV to assist in securing cargo stowed in the carrier so it is not lost or damaged while subsequently being transported from one place to another. The keeper is readily installed in a tube or channel located or formed in a side of the carrier and is adjustable so to be tightly secured in place. Once installed, the keeper remains securely in place and is not dislodged as the vehicle jounces over rough terrain so to keep what is being transported securely stowed.

The keeper includes a rod, one or both ends of which are threaded, the rod being of a length and diameter that allows it to be readily inserted through the tube or channel. A nut is threaded onto the lower threaded end of the rod and tightened down to fit the keeper in place. An eyelet is located on the upper end of the rod. Ropes or straps are passed through the eyelet so to hold down items of cargo placed in the bed of the carrier. D-rings, snaffles and the like on the ends of straps can also be readily attached to the eyelet to help provide a stable and firm connection for the tie down.

In one embodiment of the keeper, a round eyelet is located on the one end of the rod. In a second embodiment, a swivel eyelet is rotatably affixed to this end of the rod to facilitate passage of the ropes or straps, or the attachment of D-rings and the like.

The keeper can be used individually or in sets so to effectively secure the cargo in the carrier.

The keeper is low cost, easy to install and uninstall. When not in use, the keeper can be stored in the bed of the carrier for future use.

The keeper is strong so as not to bend or twist during vehicle movement over rough terrain so to keep cargo safe and secure.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 illustrates a plurality of keepers installed in a carrier of an ATV or UTV for transporting items from one place to another;

FIG. 2 is an elevation view of a keeper of the present invention prior to its installation on a carrier;

FIG. 3 illustrates use of the keeper with a tie-down to secure stowed items in place; and,

FIG. 4 illustrates a second embodiment of the keeper using a swivel eyelet.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, an off-road vehicle such as an all-terrain vehicle (ATV) is indicated generally A. Installed on the back of the vehicle is cargo carrier C in which is stowed items I to be transported from one place to another, usually over rugged terrain. Accordingly, to prevent cargo damage or loss, a tie down arrangement is used to secure the stowed items of cargo in place. This includes the use of ropes, straps, or belts, etc., all of which are indicated generally T, and which are fitted over and about the cargo. Rings or hooks and/or buckles, all generally indicated B, are fitted on or near the ends of the ropes, etc. and are used to secure the ropes, etc., T in place and sufficiently tighten them down that the items of cargo will not be thrown or fall out of the carrier as vehicle A traverses over the terrain, nor bump or jostle against other pieces of cargo and damage them.

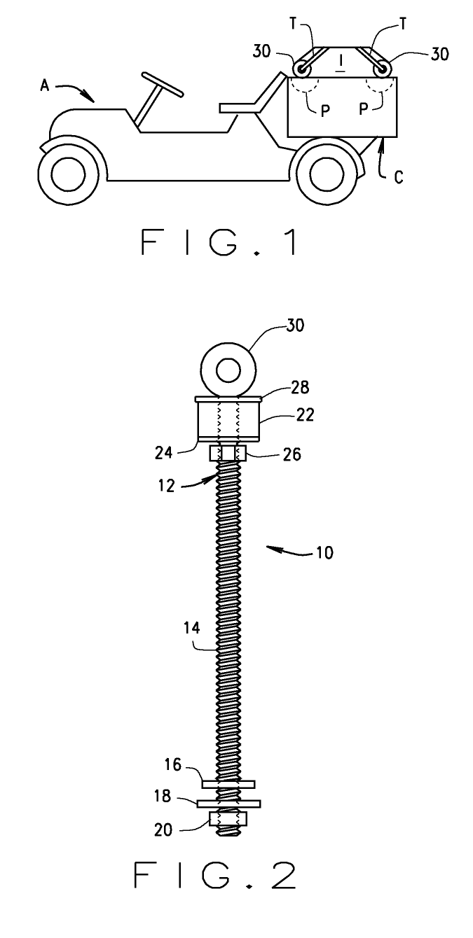

As shown in FIG. 2, a keeper 10 is for use with the ropes, straps, and belts of a tie down to anchor these pieces in place. As shown in FIG. 1, in a typical installation, a plurality of keepers 10 are used, these being positioned around the perimeter of the carrier so the ropes, etc. can be threaded through them; or an end of the rope, strap, or belt attached to them.

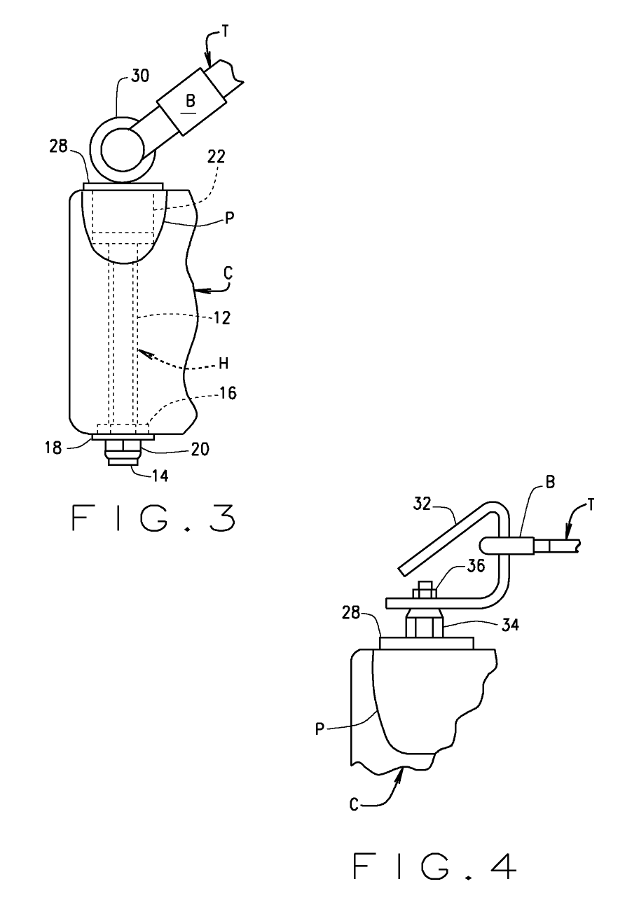

Keeper 10 first includes a rod 12 whose length corresponds to the height of carrier C. One end 14 of rod 12 is threaded for securing the rod to the carrier. As shown in FIGS. 1 and 3, a plurality of spaced pockets P is formed in the upper end of the carrier and channels H extend vertically through sidewalls of the carrier from the lower end of the pocket to the bottom of the carrier. Each pocket is sized to receive a keeper 10 with rod 12 extending through a channel H. The threaded end 14 of keeper 10 is inserted through an opening in the bottom of a pocket P, through channel H and through another opening in the bottom of the carrier. This is as shown in FIG. 3.

Keeper 10 is attached to carrier C first using a washer 16 sized to fit over threaded end 14 of rod 12, as well as fit into a space about the opening formed in the bottom of the carrier. This washer prevents rod “walk” when the keeper is tightened down. Next, a second and larger size washer 18 also fits onto the threaded end of rod 12. This washer is attached to washer 16 and bears against the bottom outer surface of the carrier. Those skilled in the art will appreciate that in some installations, washer 16 does not have to be used. Finally, a threaded nut 20 is received onto the threaded end of the rod and is tightened down to secure keeper 10 in place. This can be done, for example, using a ½″ open end wrench, or a ⅜″ ratchet with a ½″ socket.

A rubber bushing 22 is attached to the other end of rod 12. The diameter and shape of bushing 22 corresponds to that of the opening in the top of pocket P. A washer 24 is installed adjacent the lower end of the bushing and a nut 26 is fitted on the rod beneath the washer. The position of nut 24 is adjustable to accommodate bushing 22 in pocket P, the bushing acting as an expansion plug so to insure a secure fit within the pocket. A washer 28 fits over the outer end of bushing 22 and bears against the upper, outer surface of carrier C when keeper 10 is installed.

As also shown in FIG. 2, in another embodiment of the invention, the length of rod 12 is further adjustable. In this embodiment, the upper end of rod 12 is joined to its lower, threaded end 14 by an internally threaded coupler 31. The coupler allows rod 12 to be lengthened or shortened as appropriate.

Next, an eyelet 30 of the keeper protrudes above the upper surface of carrier C when keeper 10 is in place. The tie down (rope, strap, or belt T) used to secure items I in the carrier is now fitted through the eyelet, or attached to the eyelet, for the eyelet to hold the tie down in place. As shown in FIG. 3, for example, the end of a strap is inserted through the eyelet and then through a buckle B which is used to tighten the strap about the cargo. In this regard, it will be appreciated that eyelet 30 can be rotated to a desired position to facilitate the tie down.

As shown in FIG. 4, a hook B is attached to a swivel connector 32 for the same purpose.

Once the tie down is completed, the items stowed in the carrier bed will remain there regardless of the terrain traversed by the vehicle as it moves the cargo from the one place to the other.

Referring to FIG. 4, swivel eyelet 32, which is generally of a C-shape, can be used on a keeper 10 in place of eyelet 30. In this embodiment, the upper end of rod 12 is also threaded and a nut 34 and cap 36 are used to mount and hold the eyelet on the end of the keeper so that it can freely rotate.

In view of the above, it will be seen that the several objects and advantages of the present disclosure have been achieved and other advantageous results have been obtained.

Having thus described the invention, what is claimed and desired to be secured by Letters Patent is:

1. A keeper for use with a tie down to secure stowed items of cargo in place when being transported from one place to another in a vehicle carrier comprising:
a rod having a length substantially corresponding to the height of the carrier and sized for insertion through an opening in the carrier, at least one end of the rod being threaded;
a fastener for securing a threaded end of the rod to the carrier, the threaded end of the rod extending through one end of the opening; and,
an eyelet formed on the opposite end of the rod and which protrudes above an upper surface of the carrier when the rod is installed on the carrier, the tie down used to secure the items in the carrier being fitted through or attached to the eyelet for the eyelet to hold the tie down in place regardless of the terrain traversed by the vehicle as it moves the cargo from the one place to the other.

2. The keeper of claim 1 further including a swivel connector mounted on the opposite end of the rod for use with the tie down in securing the items in the carrier.

3. The keeper of claim 1 in which a pocket is formed in the carrier and the opposite end of the rod is installed in this pocket, the rod having a bushing on this end of the rod which is received in the pocket.

4. The keeper of claim 3 in which the bushings acts as an expansion plug to secure the opposite end of the rod in the pocket.

5. The keeper of claim 1 in which the rod is a two-piece rod in which one end of each piece is installed in a coupler, the coupler allowing the overall length of the rod to be increased or shortened.
